(19) United States
(12) Patent Application Publication
(10) Pub. No.: US 2009/0121045 A1
(43) Pub. Date: May 14, 2009

(54) Fire protection System and method

(76) Inventors: Kuojui Su, Van Nuys, CA (US); Ling-Ju Su, Van Nuys, CA (US)

Correspondence Address: Kuojui Su, 13936 Wyandotte Street, Van Nuys, CA, 91405, US

(21) Appl. No.: 12/231,914

(22) Filed: Sep. 8, 2008

Related U.S. Application Data
(60) Provisional application No. 61/002,378, filed on Nov. 8, 2007.

(51) Int. Cl. B05B 3/00; A62C 37/00

(52) U.S. Cl. 239/208; 169/16

(57) ABSTRACT

The main purpose of the present invention is to protect a house from destruction by fire. The invention includes the system and method of water coating and water recycling. The water coating system involves wetting the surface of the house. The water recycling system involves recycling the water used for wetting the house to save water and extend the time the water coating system operates. The water coating method has a water pump that pumps water from a water pool to a network of water sprinklers to wet the surface of the house. The water recycling method employs a water collection site to collect the water runoff from the sprinklers and return it back to the water pool for reuse.

### CROSS REFERENCE OF RELATED APPLICATION

This is a non-provisional application of a provisional application having an application No. 61/002,378 and a filing date of Nov. 8, 2007.

### BACKGROUND OF THE PRESENT INVENTION

1. Field of Invention

The main purpose of the present invention is to protect a house from destruction by fire. The invention includes the system and method of water coating and water recycling.

2. Description of Related Arts

This invention relates to the protection of houses from wild fires. Wild fires occur regularly in many parts of the United States when temperatures get high and humanity levels are low. We see devastation caused by wild fires take place year after year in places such as California or Northern Fla. Although fire firefighters are better trained and equipped than before, large wild fires continue to take place, overpowering firefighter resources, costing millions in property damage every year. For property owners living in wild fire prone areas, they recognize that in many cases wild fires are not preventable and can get out of control even with the best firefighter efforts. As such, the more measures property owners take to protect their properties from wild fires, the better chance they will have of preventing loss of property damage.

The present invention offers protection by continuously coating the house with water to prevent it from catching fire during the approach of a wildfire. The invention recycles the water used to coat the house to extend the time the water coating the house. The new fire protection system is inexpensive and durable. It is a reliable system and method for property owners to prevent their houses from being destroyed by wild fires.

### SUMMARY OF THE PRESENT INVENTION

The main purpose of the present invention is to protect a house from destruction by fire. The invention includes the system and method of water coating and water recycling. The water coating system involves wetting the surface of a house with water to protect the house from catching fire. The water recycling system involves recycling the water used for wetting the house to extend the time the water coating system operates.

The water coating method involves a water pump that pumps water from a water recycling pool to a network of water sprinklers to wet the surface of the house. The water recycling method employs a water collection site to collect the water runoff from the sprinklers and return it back to the water recycling pool to be filtered for reuse. The water coating system includes: a water pump for pumping water from the water recycling pool to supply water to the water sprinklers to wet the surface of the house. The water recycling system includes: a water collection site for collecting the water runoff from the sprinklers, and a water recycling pool for depositing water coming from the water collection site.

Each water sprinkler is located at a location where it can wet the targeted areas effectively. Water is pumped to the sprinklers by a water pump. The water sprinklers can be installed on the roof, on the wall, on the ground, or any other suitable locations. For example, the water sprinklers can be installed under the roof eaves around the house to wet the exterior walls and/or the surrounding of the house; they can be installed over the roof to wet the roof and/or the surrounding of the house; or be installed on the ground around the house to wet the roof, the exterior walls, and/or the surrounding of the house. The types of water sprinklers used depend on where the sprinklers are installed and how they're installed. The fire protection system can be pre-installed on a new building or installed when desired. When pre-installing the fire protection system on a new building, the builder can elect to install the water pipes inside the wall to keep the appearance of the building intact.

The protection of a house from destruction by fire depends heavily on having a continuous supply of water. The water collection site plays a major role in the supply of water. The water collection site consists of the grounds surrounding the house. Its main purpose is to catch the water runoff from the water sprinklers. The bottom of the water collection site is composed of waterproofed materials. There are one or more water outlets from the water collection site for releasing the water collected in the collection site to the water recycling pool. The water collection site can be exposed or hidden. It may be covered by grass or other materials to keep the appearance of the surrounding of the building intact. The shape of the water collection site is determined by the shape of the property on which the house sits. The function of the water collection site of the present invention is to catch and collect the water runoff from the sprinklers and to deliver the water to the water recycling pool for recycling and reuse. The water collection site may cover a large or small area around the house as long as it can effectively catch the water runoff from the sprinklers.

One or more outlets from the water collection site deliver the collected water from the water collection site to the water recycling pool. The used water that is collected in the water collection site is usually murky and dirty. To reuse the water again it has to be filtered first to prevent buildup in the sprinklers system. The water recycling pool is used not only for storing water, but it is also where a filter is installed to clean the water before it can be reused again. Once the used water has been filtered and is ready for reuse, the water pump pumps the water through the water pipes to the sprinklers. The water pump is powered by an engine. The engine is connected to a tank that stores enough fuel such as diesel or gasoline for the engine to run for a desired period of time. The capacity of the water recycling pool for depositing water can be customized to ensure enough water is stored for the water coating system to work effectively.

The procedure of installing the new invention is as follows:

First, build the water recycling pool for depositing water. The pool should be large enough to supply enough water to wet the house for a desired period of time.

Second, build the water collection site around the house and create outlet(s) to release water from the water collection site to the water recycling pool for reuse. The site should be large enough to catch the water runoff from the water sprinklers.

Third, install the water pump for pumping the water from the water recycling pool.

Fourth, install the water sprinklers at desired locations.

Fifth, install the water pipes between the water pump and the sprinklers. The water pipes deliver the high pressure water supplied by the water pump to the water sprinklers.

The water coating system and the water recycling system of the present invention presents a fire protection system that is both effective and affordable. Many house owners would be interested in utilizing the present invention to protect their house were it made available. The objects and the advantages of the present invention may be better understood and will become apparent from the accompanying drawings.

### BRIEF DESCRIPTION OF THE DRAWINGS

FIG. 1 is a flow chart of the fire protection system according to the present invention.

FIG. 2 illustrates an installation of the present invention on a building.

FIG. 3 illustrates an installation of the present invention on a new building. This drawing shows the water collection site 102 covered with grass 301.

FIG. 4 illustrates a network of water sprinklers installed around the house on the ground according to the present invention.

FIG. 5 illustrates the water recycling pool 103 according to the present invention.

FIG. 6 illustrates the water recycling pool 103 combined with a swimming pool 601 (or other types of water pool)

### DETAILED DESCRIPTION OF THE PREFERRED EMBODIMENT

The purpose of the present invention is to protect houses in areas vulnerable to the threats of wildfires. As temperatures around the globe continue to rise, many areas around the world are becoming drier with raising temperatures and low precipitations. As such, home owners living in wildfire prone areas need to think seriously about what they can do to prevent their house being destroyed by fire. Methods or device available to them for use to help them protect their house should be considered more of a necessity than an option. It's unthinkable for those homeowners living under constant threats of wildfires not to do something to effectively prevent their property being destroyed. Homebuilders and home owners have often been advised to build houses with fire resistant materials to better stand against fires. While this is a sound advice, the use of fire resistant materials is still not enough, in many cases, to protect a house from destruction by fire. For this reason, the present invention offers a more aggressive protection system.

The fire protection system of the present inventions includes a water coating system and a water recycling system. The water coating system involves coating the surface of the house by water from the sprinklers installed on the exterior walls of the house, on the roof of the house, or on the ground around the house, or all of them. The water recycling system involves collecting and delivering the water runoff from the sprinklers to a water recycling pool to be reused again. The combination of the water coating and water recycling systems present an effective and efficient way to protect a house from fire.

The water coating system wets the surface of the house and/or the surrounding area of the house to prevent flying fire cinders, flaming debris from starting a fire on the house during a breakout of a large fire nearby. As people who have tried to set up a camp fire can testify, it's very difficult, if not impossible, to set a piece of damp log on fire, let along trying to start a fire on a piece of wood that is thoroughly wet. The water coating system adopts this basic concept by continually applying water to the surface of a building threatened by wildfire to prevent it from catching fire.

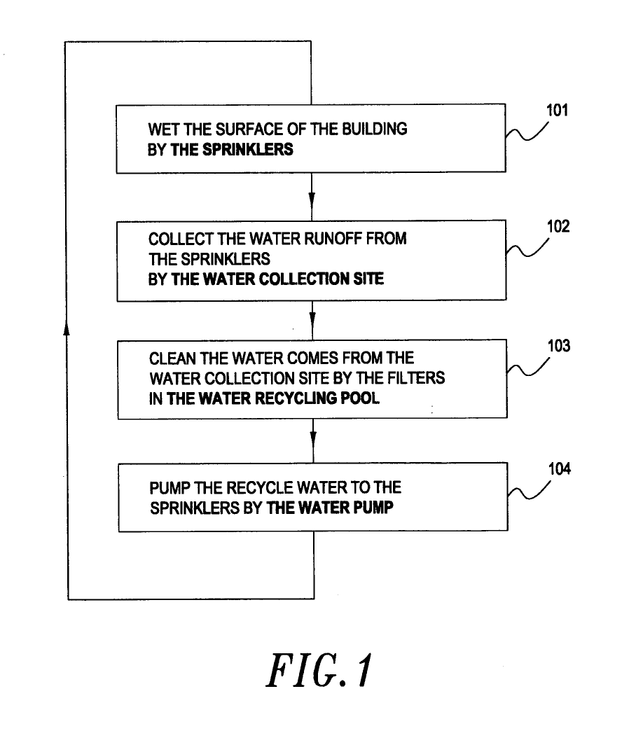

FIG. 1 is a flow chart of the fire protection system according to the present invention. The water used for fire protection is recycled as shown in this flow chart. The water used to wet the surface of the house comes from the recycling water pool 103. The water in the water recycling pool 103 is pumped by a pump 104 to the sprinklers 101 for wetting the surface of the house. The used water then flows to the water collection site 102 and is released back to the recycling pool 103 via the outlet(s). The flow chart is a simplified illustration of the water cycle.

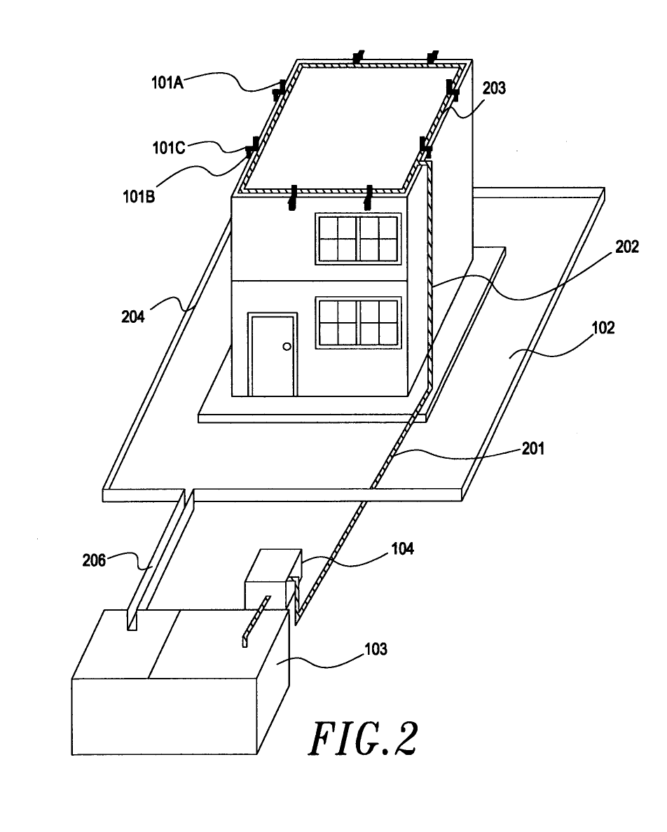

FIG. 2 illustrates an installation of the present invention on a building. The water coating system includes an engine water pump 104, a network of sprinklers 101A and water pipes 201 (underground), 202 (up the wall), 203 (around the building). The water recycling system includes a water collection site 102, a water recycling pool 103 and a water outlet 206 on one corner of the water collection site. The engine water pump 104, which is installed near the water recycling pool 103, pumps the water from the water recycling pool 103 to the water pipes 201, 202, 203. The water pipes 203 are installed all around the building. These pipes 203 are connected with the sprinklers 101A installed around the edges of the roof. These sprinklers 101A are designed to be able to rotate in 180 degrees such that they can wet the roof completely. The water pipes 203 are also connected with the sprinklers 101B installed on the walls for wetting the walls. In the drawing, the water pipes 203 are also connected with the sprinklers 101C to wet the ground close to the house to create a fire-proof area for extra protection. The water sprinklers can be of different types as long as they are able to cover the areas targeted. The water pipes can be hidden in the wall or under the ground so as not to affect the appearance of a building. In this illustration, the water collected in the water collection site 102 flows to the water recycling pool 103 via an outlet 206. The water collection site shown in the drawing has a cement bottom with a small fence around the site. Together with the fence around, the water collection site functions as a huge pan to keep the water from disappearing into the underground or surrounding areas. The cement bottom can be covered with grass or plants without impacting the function of the water collection site.

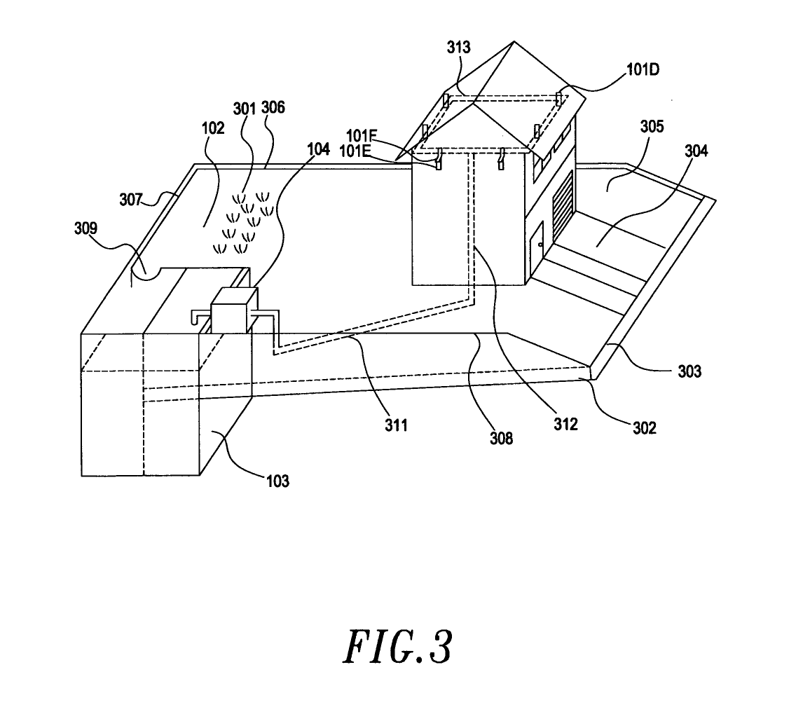

FIG. 3 illustrates an installation of the present invention on a new building. This drawing shows a water collection site 102 covered with grass 301. The shape of this water collection site is different from that of FIG. 2 but its function of collecting the runoff from the sprinklers for reuse remains the same. The front area of the house is lower than the backyard, thus the water accumulated in the front runs to an underground channel (water pipe) 302 at the edge of the ground and continues to flow to the water recycling pool 103. There is a tiny ditch 303 running at the front side of the property that leads the water from the driveway 304 and the front lawn 305 to the underground channel (water pipe) 302. The two lateral sides and the rear side of the back yard have fences 306, 307, 308, the water accumulated will be kept inside the water collection site. All the water collected in the backyard goes to the water recycling pool 103 via an outlet 309 to the water recycling pool 103. An engine water pump 104 pumps the water from the water recycling pool 103 to the underground water pipes 311, then to the water pipes 312 which are hidden in the wall of the two-story building, and also to the water pipes 313 circling around the house under the roof, hidden in the wall. The water pipes are connected to a network of sprinklers 101D installed on the roof for wetting the roof. There is also a network of sprinklers 101E connected to the water pipes 313 for wetting the walls of the building. More sprinklers 101F are connected to the water pipes 313 to wet the surrounding grounds of the house to create a fire-proof zone for extra protection. The water sprinklers can be of different types as long as they're able to effectively wet the areas targeted. In this illustration, the water collection site is designed to be suitable to covered by a garden. Such design is a great solution for creating minimal impacts to the appearance of a building or its surrounding landscape.

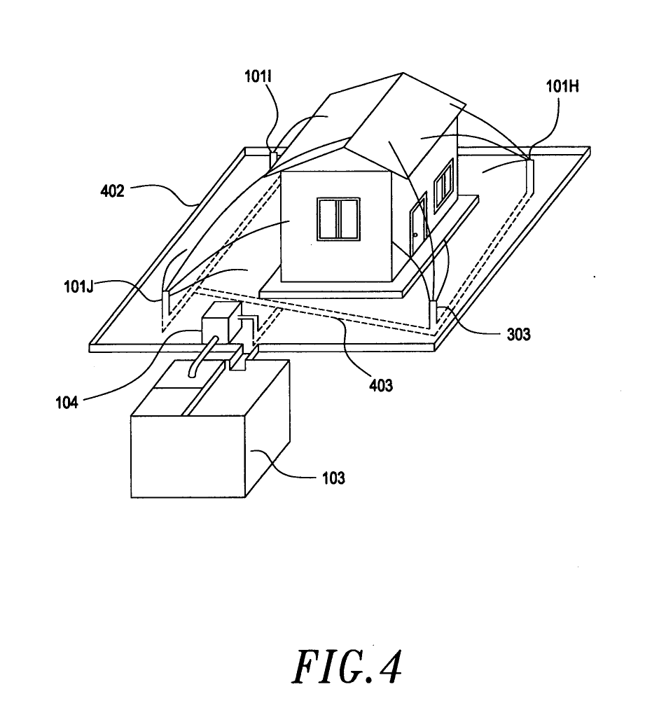

FIG. 4 illustrates a water sprinkler network installed on the ground around a house according to the present invention. This figure shows 4 sprinklers (101G, 101H, 101I, 101J) on the ground in the corners some distance away from the house. The sprinkles can be installed at any desired height. Each sprinkler has the ability to rotate 90 degrees for wide coverage. In this design, the roof, the walls and also area surrounding the house will receive water from the sprinklers. The locations and methods of how the sprinklers are installed depend on the structure of the house. The installation configuration illustrated in this figure is simple and yet effective. The bottom of the water collection site is covered by a grass field. There are fences 402 around the water collection site to keep the water inside the site 102, and there is an outlet 401 coming from the water collection site 102 for transferring the collected water to the water recycling pool 103. An engine water pump 104 is installed by the water recycling pool 103. The pump pumps the water from the water recycling pool 103 to the underground water pipes 403 that are connected to the sprinklers in the four corners of the ground.

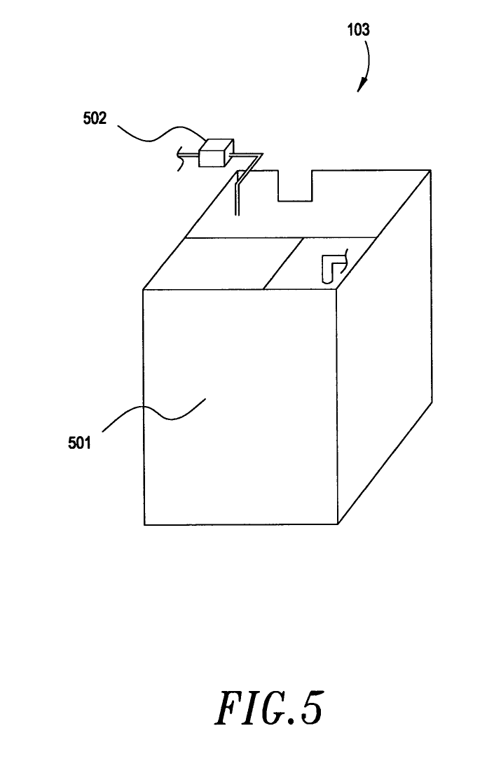

FIG. 5 illustrates a water recycling pool 103 according to the present invention. The water recycling pool 103 has two functions: one is to store a sufficient amount of water for the working of the water coating system; the other is to filter the water used for recycling. Water coming from the water collection site to the recycling pool is likely to be mixed with dirt and debris. The water filters 501 installed in the water recycling pool filters the water coming from the water collection site so the water can be reused without causing blockage in the sprinklers. The water recycling pool is also installed with a small electrical water pump 502 that pumps water out of the pool periodically to prevent the water from becoming stagnant and smelly. The water pumped out from the pool can be used to water the garden or grass. The water recycling pool can stay dry during the seasons when there are no threats of wildfires. One can also connect the water recycling pool to city water line with a water pipe for filling water to the water recycling pool.

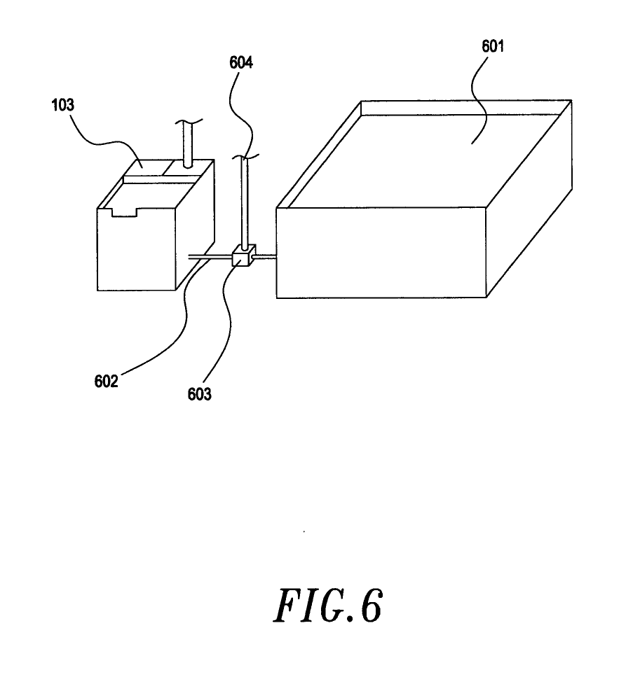

FIG. 6 illustrates a water recycling pool 103 combined with a swimming pool 601 (or other types of water pool). A water pipe 602 on the bottom of the swimming pool 601 (or other types of water pool) connects to the bottom of the water recycling pool 103 (before filter), this water pipe is connected with a water valve 603 that has a handle 604 above the ground for turning on the valve to transfer water from the swimming pool (or other types of water pool) to the water recycling pool start the operation. When a house has a swimming pool (or other types of water pool), the water recycling pool will not need to be as large. It can be built smaller to reduce construction costs. The water recycling pool is needed not only for use to store water, but it is also where used water is filtered so it can go the sprinklers.

In the above illustrations, we find that there are several methods of installing the water sprinklers. The locations, numbers of sprinklers being installed depended on the lay out of the system which focuses on the efficiency of the protection, but not limited to the above illustrations. In addition, to prevent trash, dirt from getting into the water recycling pool, the outlet(s) of the water collection site are equipped with caps to block trash, dirt out of the water recycling pool. The caps can removed out when the fire protecting system is in operation

The purpose of the present invention is to protect a house from catching fire during an outbreak of wildfire by continuously wetting the surface of the house. A network of sprinklers and water pipes are installed on and around the house to deliver water. The installation locations of the sprinklers and the types of sprinklers chosen for use depend on the structure of the house. When the surface of the house is wet, the temperature the surface of the house will be low. The damp and cold condition makes it difficult for a fire to develop. The primary purpose of the present invention is not to extinguish a fire, rather the purpose is to prevent a building from catching fire during the approach of a wildfire by preparing the building and its surroundings to be fire-proof. As stated before, this point is the foundation of the theory of the present invention.

What is claimed is:

1. A fire protection system for protecting a house from destruction by fire comprising:
a water recycling pool depositing water for fire protection;
a water filter installed in the water recycling pool and filtering recycled water collected in the pool;
a water pump connecting to the water recycling pool and pumping the filtered water from the water recycling pool;
a plurality of water sprinklers installed on the exterior parts of the house;
a plurality of water pipes connecting the water sprinklers and the water pump and delivering water pumped by the water pump to the water sprinklers;
a water collection site consisting of the grounds surrounding the house, composing of waterproofed materials at the bottom of the site, and collecting the water running off from the water sprinklers; and
at least one water outlet connecting the water collection site and the water recycling pool and delivering the water collected in the water collection site to the water recycling pool.

2. A fire protection system according to claim 1 wherein the bottom of the water recycling pool is connected with the bottom of another water container by a water pipe with a water valve that has a handle above for turning on the valve to transfer water from the water container to the water recycling pool.

3. A fire protection system according to claim 1 wherein the water sprinklers are installed on the exterior walls of the house.

4. A fire protection system according to claim 1 wherein the water sprinklers are installed on the roof of the house.

5. A fire protection system according to claim 1 wherein the water sprinklers are installed under the roof eaves around the house.

6. A fire protection system according to claim 1 wherein the water collection site are covered with grass.

7. A fire protection system for protecting a house from destruction by fire comprising:
a water recycling pool depositing water for fire protection;
a water filter installed in the water recycling pool and filtering recycled water collected in the pool;
a water pump connecting to the water recycling pool and pumping the filtered water from the water recycling pool;
a plurality of water sprinklers installed on the ground around the house;
a plurality of water pipes connecting the water sprinklers and the water pump and delivering water pumped by the water pump to the water sprinklers;
a water collection site consisting of the grounds surrounding the house, composing of waterproofed materials at the bottom of the site, and collecting the water running off from the water sprinklers; and
at least one water outlet connecting the water collection site and the water recycling pool and delivering the water collected in the water collection site to the water recycling pool.

8. A fire protection system according to claim 7 wherein the bottom of the water recycling pool is connected with the bottom of another water container by a water pipe with a water valve that has a handle above for turning on the valve to transfer water from the water container to the water recycling pool.

9. A fire protection system according to claim 7 wherein the water sprinklers are installed at any desired height.

10. A fire protection system according to claim 7 wherein the water collection site are covered with grass.

11. A method for protecting a house from destruction by fire comprising the steps of
(a) wetting the surface of the building by a plurality of water sprinklers;
(b) collecting the water running off from the water sprinklers through a water collection site to a water recycling pool;
(c) filtering the recycled water with a water filter installed in the water recycling pool;
(d) pumping the filtered water from the water recycling pool to the water sprinklers to wet the house continuously; and
(e) repeating step (b) to (d) to recycle and reuse the water for fire protection.

12. A method for protecting a house from destruction by fire according to claim 11 wherein the water sprinklers are installed on the exterior walls of the house.

13. A method for protecting a house from destruction by fire according to claim 11 wherein the water sprinklers are installed on the roof of the house.

14. A method for protecting a house from destruction by fire according to claim 11 wherein the water sprinklers are installed under the roof eaves around the house.

15. A method for protecting a house from destruction by fire according to claim 11 wherein the water sprinklers are installed on the ground around the house at any desired height.

16. A method for protecting a house from destruction by fire according to claim 11 wherein the water collection site consists of the grounds surrounding the house and composes of waterproofed materials at the bottom of the site.
